(19) United States
(12) Patent Application Publication
(10) Pub. No.: US 2017/0036242 A1
(43) Pub. Date: Feb. 9, 2017

(54) HARD COATING FILM AND FLEXIBLE DISPLAY HAVING THE SAME

(71) Applicant: DONGWOO FINE-CHEM CO., LTD., Iksan-si (KR)

(72) Inventors: Jeong Eun LEE, Cheonan-si (KR); Seungwoo LEE, Hwaseong-si (KR); Seung Mo HONG, Incheon (KR)

(73) Assignee: DONGWOO FINE-CHEM CO., LTD., Iksan-si (KR)

(21) Appl. No.: 15/229,213

(22) Filed: Aug. 5, 2016

(30) Foreign Application Priority Data
Aug. 6, 2015 (KR) 10-2015-0110969

(51) Int. Cl. B05D 7/00; B05D 1/00; B05D 1/28; B05D 1/02

(52) U.S. Cl. CPC B05D 7/50; B05D 1/02; B05D 1/005; B05D 1/28

(57) ABSTRACT

Provide are a hard coating film for a flexible display, including a transparent substrate; a first hard coating layer formed on one surface of the transparent substrate; and a second hard coating layer formed on the other surface of the transparent substrate, wherein the first hard coating layer and the second hard coating layer each have a thickness of 5 to 50 μm and satisfy a stiffness of 15 to 130 kPa·m, and a flexible display having the hard coating film. The hard coating film has high hardness and excellent flexibility.

### TECHNICAL FIELD

The present invention relates to a hard coating film and a flexible display having the same. Particularly, the present invention provides a hard coating film having good hardness and flexibility, and a flexible display having the hard coating film.

### BACKGROUND ART

A hard coating film has been used for protecting the surface of various image displays including a liquid crystal display device (LCD), an electroluminescence (EL) display, a plasma display (PD), a field emission display (FED) and the like.

Such a hard coating film should have high hardness and good scratch-resistance, without curling in the end thereof during its production or use. Recently, a flexible display gains attention as a next-generation display device for the reason that the flexible display applies flexible materials such as plastics, instead of a glass substrate having no flexibility, making it capable of maintaining display performances even though it is bent like paper. Accordingly, the hard coating film is also required to have proper flexibility so as to prevent the generation of crack,

Korean Patent Application Publication No. 2014-0027023 discloses a hard coating film which comprises a supporting substrate; a first hard coating layer formed on one surface of the substrate and comprising a first photocurable cross-linked copolymer; and a second hard coating layer formed on the other surface of the substrate and comprising a second photocurable cross-linked copolymer and inorganic particles distributed in the second photocurable cross-linked copolymer, thereby exhibiting high hardness, resistance to impact and scratch, and high transparency.

However, the hard coating film has insufficient flexibility and it is difficult to be applied in a flexible display,

### DISCLOSURE

### Technical Problem

It is an object of the present invention to provide a hard coating film for a flexible display, the film having flexibility together with good hardness.

It is another object of the present invention to provide a flexible display having the hard coating film.

### Technical Solution

In accordance with one aspect of the present invention, there is provided a hard coating film, comprising:

a transparent substrate;

a first hard coating layer formed on one surface of the transparent substrate; and

a second hard coating layer formed on the other surface of the transparent substrate,

wherein each of the first hard coating layer and the second hard coating layer has a thickness of 5 to 50 μm and satisfies a stiffness of 15 to 130 kPa·m, which is defined by the following Equation 1:

Stiffness (kPa·m)=Compressive Elastic Modulus (GPa)×Layer Thickness (μm) [Equation 1]

In one embodiment of the present invention, the first hard coating layer may have a compressive elastic modulus of 3,000 to 15,000 MPa, and the second hard coating layer may have a compressive elastic modulus of 3,000 to 10,000 MPa.

In one embodiment of the present invention, the first hard coating layer may have a pencil hardness of 4H or more which is tested with a load of 750 g, and the second hard coating layer may have a pencil hardness of H or more which is tested with a load of 750 g.

In one embodiment of the present invention, the hard coating film may have a pencil hardness of or more which is tested with a load of 750 g in the state that the second hard coating layer is attached to an adhesive.

In accordance with another aspect of the present invention, there is provided a flexible display having the hard coating film.

### Advantageous Effects

The hard coating film of the present invention has high hardness and excellent flexibility, and thus it can be effectively used in a flexible display.

### BEST MODE

The present invention is, hereinafter, described in more detail.

One embodiment of the present invention relates to a hard coating film for a flexible display, comprising a transparent substrate; a first hard coating layer formed on one surface of the transparent substrate and a second hard coating layer formed on the other surface of the transparent substrate, wherein each of the first hard coating layer and the second hard coating layer has a thickness of 5 to 50 μm and satisfies a stiffness of 15 to 130 kPa·m, which is defined by the following Equation 1:

Stiffness (kPa·m)=Compressive Elastic Modulus (GPa)×Layer Thickness(μm) [Equation 1]

The hard coating film according to one embodiment of the present invention has hard coating layers with a thin thickness of 5 to 50 μm and a stiffness of 15 to 130 kPa·m on both surfaces thereof, thereby providing flexibility together with good hardness. Particularly, the hard coating film is applied with tensile stress from an outward direction when it is folded or bent, which allows the alleviation of crack generation in the hard coating layers.

In one embodiment of the present invention, the first hard coating layer may have a compressive elastic modulus of 3,000 to 15,000 MPa, and the second hard coating layer may have a compressive elastic modulus of 3,000 to 10,000 MPa. By controlling the compressive elastic modulus of each hard coating layer within such ranges, the hardness and flexibility thereof can be improved.

In the present invention, the method of measuring the compressive elastic modulus is not particularly limited. For example, the compressive elastic modulus may be measured according to the method illustrated in Experimental Examples below.

In one embodiment of the present invention, the first hard coating layer may have a pencil hardness of 4H or more which is tested with a load of 750 g, and the second hard coating layer may have a pencil hardness of H or more which is tested with a load of 750 g.

In the present invention, the method of measuring the pencil hardness is not particularly limited. For example, the pencil hardness may be measured according to the method illustrated in Experimental Examples below.

In one embodiment of the present invention, the hard coating film may have a pencil hardness of H or more which is tested with a load of 750 g in the state that the second hard coating layer is attached to an adhesive. The adhesive may have a thickness of 25 μm or more, and it may be a pressure sensitive adhesive (PSA) or an optically clear adhesive (OCA).

In the present invention, the method of measuring the pencil hardness after attachment of the adhesive is not particularly limited. For example, the pencil hardness may be measured according to the method illustrated in Experimental Examples below.

The hard coating film according to one embodiment of the present invention may be prepared by applying and curing each hard coating composition on both surfaces of a transparent substrate to form a first hard coating layer and a second hard coating layer.

As the transparent substrate, any plastic film may be used if it has transparency. For example, the transparent substrate may be selected from films made of cycloolefin derivativeshaving a cvcloolefin monomer units, such as norborn MC or polycyclic flOrbOMelle monomers; celluloses (diacetyl cellulose, triacetyl cellulose, cellulose acetate butyrate, cellulose isobutyrate, cellulose propionate, cellulose butyrate, cellulose acetate propionate), a copolymer of ethylene-vinyl acetate, polyester, polystyrene, polyamid.e, polyether imide, polyacrylate, polyimide, polyether sulfone, polysulfone, polyethylene, polypropylene, polyrnethylpentehe, polyvinyl chloride, polyvirtylidene chloride, polyvinyl alcohol, polyvinyl acetal, polyether ketone, polyether ether ketone, polymethyl methacrylate, polyethylene terephthalate, poly butylene terephthalate, polyethylene naphthalate, polycarbonate, polyurethane or epoxy. Also, a non-stretched, uniaxiaily or biaxially stretched film may be used.

The thickness of the transparent substrate is not particularly limited, It may ranges from 8 to 1,000 μm, particularly 20 to 150 μm. If the thickness of the transparent substrate is less than 8 μm, the strength of the hard coating film may be lowered to deteriorate processibility. If the thickness of the transparent substrate is higher than 1,000 μm, the transparency of the hard coating film may be deteriorated or the weight thereof may be raised.

The hard coating composition used to form the first and second hard coating layers may comprise a photocurable resin, a photoinitiator and a solvent. Particularly, the hard coating composition for forming the first hard coating layer may further comprise a silica sol containing nanosilica particles having a diameter of 10 to 100 nm.

The photocurable resin may comprise a photocurable (meth)acrylate oligomer an or monomer.

The photocurable (meth)acrylate oligomer may be epoxy (meth)acrylate, urethane (meth)acrylate and the like, which have been conventionally used. Among these, urethane (meth)acrylate is more preferred. The urethane (meth)acrylate may be prepared by reaction of a polyfunctional (meth)aciylate having a hydroxyl group with a. compound having an isocyanate group in the presence of a catalyst.

The polyfunctional (meth)acrylate having a hydroxyl group may be at least one selected from the group consisting of 2-hydroxyethyl (meth)acrylate, 2-hydroxyisopropyl (meth)acrylate, 4-hydroxybutyl (meth)acrylate, caproiactone ring-opening hydroxyacrylate, a mixture of pentaerythritol tri/tetra(meth)acrylates and a mixture of dipentaerythritol penta/hexa(meth)acrylates

Also, the compound having an isocyanate group may be at least one selected from the group consisting of tri-functional isocyanates derived from 14-dilsocyanatobutane, 1,6-diisocyanatohexane, 1,8-diisocyanatooctane, 1,12-diisocyanatododecane, 1,5-diisocyanato-2-methylpentane, trimethyl-1,6-diisocyanatohexane, 1,3-bis(isocyanatomethyl)cyclohexane, trans-1,4-cyclohexene diisocyanate, 4,4′-methylene-bis(cyclohexyl isoanate), isophorone diisocyanate, toluene-2,4-diisocyanate, toluene-2,6-diisocyanate, xylene-1,4-diisocyanate, tetramethyxylene-1,3 -di isocy anate, 1-chloromethyl-2,4-diisocyanate, 4,4′-methylene-bis(2,6-dimethylphenyl isocyanate), 4,4-oxybis(phenyl isocyanate), trifunctional isocyanate derived from hexamethylene diisocyanate, and an adduct of trimethyl propanol and toluene diisocyanate.

The monomer may be any one being conventionally used in the art. Specific examples of the monomer may include compounds having a photocurable functional group, such as an unsaturated group of (meth)acryloyl, vinyl, slyryl, allyl or the like, preferably (meth)acryloyl group.

The monomer having a (meth)acryloyl group may be at least one selected from the group consisting of neopentyl glycol acrylate, 1,6-hexanediol (meth)acrylate, propylene glycol di(meth)acrylate, triethylene glycol di(meth)acrylate, dipropylene glycol di(meth)acrylate, polyethylene glycol di(meth)acrylate, polypropylene glycol di(meth)acrylate, trimethylolpropane tri(meth)acrylate, trimethylolethane tri(meth)acrylate, 1,2,4-cyclohexane tetra(meth)acrylate, pentaglycerol tri(meth)acrylate, pentaerythritol tetra(meth)acrylate, pentaerythritol tri(meth)acrylate, dipentaerythritol tri(meth)acrylate, dipentaerythritol penta(meth)acrylate, dipentaerythritol tetra(meth)acrylate, dipentaerythritol hexa(meth)acrylate, tripentaerythritol tri(meth)acrylate, tripentaerythritol hexa(meth)acrylate, bis(2-hydroxyethyl) isocyanurate di(meth)acrylate, hydroxyethyl (meth)acrylate, hydroxypropyl (meth)acrylate, hydroxybutyl (meth)acrylate, isooctyl (meth)acrylate, iso-decyl (meth)acrylate, stearyl (meth)acrylate, tetrahydrofurfuryl (meth)acrylate, phenoxyethyl (meth)acrylate, and isobornyl (rneth)acry I ate.

The photocurable resin may be present in an amount of 20 to 90 wt %, preferably 30 to 60 wt %, based on 100 wt % of the hard coating composition. If the amount of the ph tocurable resin is less than 20 wt %, it is difficult to increase the coating thickness and obtain suffici ent mechanical strength. If the amount of the photocurable resin is higher than 90 wt %, the coating property may be severely deteriorated, thereby leading to poor appearance and making it difficult to obtain uniform thickness.

The photoinitiator may be, without limitation, any one being used in the art. Specifically, the photoinitiator may be at least one selected from the group consisting of 2-methy-1-[4-(methylthio)phenyl]2-morpholin-propanone-1, diphenyl ketone, benzyl dimethyl ketal, 2-hydroxy-2-methyl-1-phenyl-1-one, 4-hydroxycyclohexyl phenl ketone, dimethoxy-2-phenyl acetophenone, anthraquinone, fluorene, triphenylarnine, carbazole, 3-methyl acetophenone, 4-chloroacetophenone, 4,4-dimethoxy acetophenone, 4,4-diamino benzophenone, 1-hydroxycyclohexyl phenyl ketone and benzophenone.

The photoinitiator may be present in an amountof 0.1 to 10 wt based on 100 wt % of the hard coating composition. If the amount of the photoinitiator is less than 0.1wt %, the curing rate may be lowered. If the amount of the photoinitiator is higher than 10 wt %, the curing may excessively occur to generate crack in the hard coating layer.

The solvent may be, without limitation, any one being used in the art. Specific examples of the solvent may include alcohols (methanol, ethanol, isopropanol, butanol, etc.), cellosolves (methyl cellosolve, ethyl cellosolve, etc.), ketones (methyl ethyl ketone, methyl butyl ketone, methyl isobutyl ketone, diethyl ketone, dipropyl ketone, cyclohexanone, etc.), hexanes (hexane, heptane, octane, etc.), benzenes (benzene, toluene, xylene, etc.). These sovlents may be used alone or in a combination of two or more.

The solvent may be present in an amount of 10 to 80 wt %, preferably 30 to 60 wt %, based on 100 wt % of the hard coating composition. If the amount of the solvent is less than 10 wt %, the viscosity may increase to deteriorate workability. If the amount of the solvent is higher than 80 wt %, the time of drying and curing may increase and it is difficult to increase the thickness of the hard coating film.

The hard coating composition, if necessary, may further comprise other components which have been conventionally used in the art, e.g., a leveling agent, a UV stabilizer, a thermal stabilizer, an antioxidant, a surfactant, a lubricant, an anti-fouling agent, etc.

The leveling agent may be used to provide the smoothness of a coating film formed from the hard coating composition and enhance the coating property of the composition. As the leveling agent, silicon-type, fluorine-type and acrylic polymer-type leveling agents being commercially available may be used. For example, BYK-3530, BYK-323, BYK-331, BYK-333, BYK-337, BYK-373, BYK-375, BYK-377 and BYK-378 (BYK Chemie), TEGO Glide 410, TEGO Glide 411, TEGO Glide 415, TEGO Glide 420, TEGO Glide 432, TEGO Glide 435, TEGO Glide 440, TEGO Glide 450, TEGO Glide 455, TEGO Rad 2100, TEGO Rad 2200N, TEGO Rad 2250, TEGO Rad 2300 and TEGO Rad 2500 (Degussa), FC-4430 and FC-443 (3M) may be used. The leveling agent may be present in an amount of 0.1 to 1 wt %, based on 100 wt % of the hard coating composition.

The hard coating composition may be suitably applied on the transparent substrate by the known coating processes using die coater, air knife, reverse roll, spray, blade, casting, gravure, micro gravure, spin coating, etc.

After applying the hard coating composition on the transparent substrate, a drying process may be carried out by vaporizing volatiles at a temperature of 30 to 150° C. for 10 seconds to one hour, more specifically 30 seconds to 30 minutes, followed by UV curing. The UV curing may be carried out by the irradiation of UV-rays at about 0.01 to 10 J/cm², particularly 0.1 to 2J/cm².

One embodiment of the present invention relates to a flexible display having the hard coating film. For example, the hard coating film of the present invention may be attached to the window of the flexible display.

The hard coating film according to one embodiment of the present invention may be used in liquid crystal devices (LCDs) of various operation modes, including reflective, transmissive, transfiective, twisted nematic (TN), super-twisted nematic (STN), optically compensated bend (OCB), hybrid-aligned (HAN), vertical alignment (VA)-type and in-plane switching (IPS) LCDs. Also, the hard coating film according to one embodiment of the present invention may be used in various image display devices, including plasma. displays, field emission displays, organic EL displays, inorganic EL displays, electronic paper and the like.

The present invention is further illustrated by the following Examples, Comparative Examples and Experimental Examples, which are not to be construed to limit the scope of the invention.

### Preparation Example 1

### Preparation of First Hard Coating Layer-Forming

### Composition

25 wt % of Silica sot in isopropanol (IPA-ST-1, Nissan Chemical, particle size 20-30 nm), 15 wt % of deca(10)-functional urethane acrylate oligomer (UV1000, Shin-A T&C), 18.5 wt % of tri-functional monomer (M340, MIRAMER), 1.2 wt % of a photoinitiator (I-184, BASF), 0.3 wt % of a leveling agent (BYK-3530, BYK Chemie) and 40 wt % of methyl ethyl ketone (MEK) were mixed to give a first hard coating layer-forming composition.

### Preparation Example 2

### Preparation of Second Hard Coating Layer Forming Composition

### Preparation Example 2-1

7 wt % of deca-functional urethane acrylate oligomer (UV1000, Shin-A T&C), 38.5 wt % of tri-functional monomer (M340, MIRAMER), 1.2 wt % of a photoinitiator (I-184, BASF), 0.3 wt % of a leveling agent (BYK-3530, BYK Chemie) and 53 wt % of methyl ethyl ketone (MEK) were mixed to give a second hard coating layer-forming composition.

### Preparation Example 2-2

7 wt % of deca-functional urethane acrylate oligomer (UV1000, Shin-A T&C), 38.5 wt % of di-functional monomer (M200, MIRAMER) 1.2 wt % of a photoinitiator (I-184, BASF), 0.3 wt % of a leveling agent (BYK-3530, BYK Chemie) and 53 wt % of methyl ethyl ketone (MEK) were mixed to give a second hard coating layer-forming composition.

### Preparation Example 2-3

38 wt % of deca-functional urethane acrylate oligomer (UV1000, Shin-A T&C), 7.5 wt % of di-functional monomer (M200, MIRAMER), 1.2 wt % of a photoinitiator (I-184. BASF), 0.3 wt % of a leveling agent (BYK-3530, BYK Chemie) and 53 wt % of methyl ethyl ketone (MEK) were mixed to give a second hard coating layer-forming composition.

### Examples 1 to 3 and Comparative Examples 1 to 3

### Preparation of Hard Coating Film

### Example 1

The first hard coating layer-forming composition prepared in Preparation Example 1 was coated on one surface of a polyimide (PI) film (50 μm) in a thickness of 20 μm, dried at an 80° C. oven for 1 minute, and cured by exposing it to light of 350 mJ/cm² using, a high-pressure mercury lamp to form a first hard coating layer. The second hard coating layer-forming composition prepared in Preparation Example 2-1 was coated on the other surface of the polyimide (PI) film in a thickness of 5 μm, dried at an 80° C. oven for 2 minute, and cured by exposing it to light of 350 mJ/cm² using a high-pressure mercury lamp to form a second hard coating layer. Thereby, a hard coating film was prepared.

The prepared hard coating film was measured for its properties according to the method described below, and the results thereof are shown in Table 1.

### Example 2

The procedure of Example 1 was repeated except that the second hard coating layer-forming composition was coated in a thickness of 15 μm to prepare a hard coating film.

### Example 3

The procedure of Example 1 was repeated except that the second hard coating layer-forming composition was coated in a thickness of 25 μm to prepare a hard coating film.

### Comparative Example 1

The procedure of Example 1 was repeated except that the second hard coating layer was not formed to prepare a hard coating film.

### Comparative Example 2

The procedure of Example 1 was repeated except that the second hard coating layer-forming composition prepared in Preparation Example 2-2 was coated in a thickness of 10 μm to prepare a hard coating film.

### Comparative Example 3

The procedure of Example 1 was repeated except that the second hard coating layer-forming composition prepared in Preparation Example 2-3 was coated in a thickness of 10 μm to prepare a hard coating film.

### Experimental Example 1

The prepared hard coating films were measured for their properties according to the method described below, and the results thereof are shown in Table 1.

### (1) Compressive Elastic Modulus

Each hard coating layer was measured for its compressive elastic modulus at the center of the surface thereof by a nano indentation method using PICODENTOR HM-500 (Fisher Instruments). The measurement was carried out at 25° C. and 50% humidity. For each hard coating layer, 5 measurements were performed and the average value thereof was calculated.

### l(2) Pencil Hardness

The hard coating film was placed on a glass substrate and measured for its pencil hardness using Mitsubishi pencils under a load of 750 g through a pencil hardness tester (PHT, Sukbo Science, Korea). For each pencil hardness, 5 measurements were performed.

Meanwhile the pencil hardness after attachment of an adhesive was evaluated by forming an adhesive layer in 50 μm thickness on a glass substrate and attaching the hard coating film on the adhesive layer so that the second hard coating layer comes into contact with the adhesive layer (first hard coating layer/substrate/second hard coating layer/adhesive/glass substrate in order from top to bottom).

### (3) Bending Test

The hard coating film was bent on 4 mm- and 6 mm-sized cyclic bending testers (Covotech) so that the first hard coating layer was curved inwardly and the generation of crack on the film was checked. Such a bending test was carried out by repeating 200,000 bendings. The number of bending was input in the above testers, followed by confirming the position and the bending numbers when crack (rupture) was generated, through a real time camera. Each evaluation was performed by n=3.

### (4) Stiffness

The stiffness of the hard coating film was calculated by the following Equation 1, using the compressive elastic modulus as measured above.

Stiffness (kPa·m)=Compressive Elastic Modulus (GPa)×Layer Thickness (μm) [Equation 1]

TABLE 1

| | | Examples | | | Comparative Examples | | |
|---|---|---|---|---|---|---|---|
| | | 1 | 2 | 3 | 1 | 2 | 3 |
| First Hard | Thickness (μm) | 20 | 20 | 20 | 20 | 20 | 20 |
| Coating | Stiffness (kPa · m) | 116 | 116 | 116 | 116 | 116 | 116 |
| Layer | Compressive Elastic | 5786 | 5786 | 5786 | 5786 | 5786 | 5786 |
| | Modulus (MPa) | | | | | | |
| | Pencil Hardness | 5H | 5H | 5H | 5H | 5H | 5H |
| Second Hard | Thickness (μm) | 5 | 15 | 25 | 0 | 10 | 10 |
| Coating | Stiffness (kPa · m) | 17 | 50 | 87 | — | 14 | 140 |
| Layer | Compressive Elastic | 3423 | 3350 | 3480 | — | 1400 | 14000 |
| | Modulus (MPa) | | | | | | |
| | Pencil Hardness | H | 2H | 3H | — | B | HB |

| | | | | | | |
|---|---|---|---|---|---|---|
| Pencil Hardness of Hard Coating Film | 5H | 5H | 5H | 5H | 5H | 5H |
| Before Attachment of Adhesive | | | | | | |
| Pencil Hardness of Hard Coating Film | H | H | H | 6B | 6B | 6B |
| After Attachment of Adhesive | | | | | | |
| Bending Number of Hard Coating Film (2R) | 100,000 | 70,000 | 50,000 | 10,000 | 70,000 | 5,000 |
| Bending Number of Hard Coating Film (3R) | 200,000 | 100,000 | 70,000 | 30,000 | 150,000 | 15,000 |

As can be seen from Table 1, the hard coating films of Examples 1 to 3 have hard coating layers on both surfaces thereof and satisfy stiffness values ranging from 15 to 130 kPa·m, thereby exhibiting high pencil hardness after attachment of the adhesive, as compared with that of Comparative Example 1 having only a single hard coating layer on one surface and those of Comparative Examples 2 and 3 wherein the stiffness values depart from such range. Also, in the bending test, the hard coating films of Examples 1 to 3 exhibited better _flexibility results than those of Comparative Examples 1 to 3, i.e., the films of Examples 1 to 3 were ruptured in the higher number of bending in the condition of the same thickness. Therefore, the hard coating films of Examples 1 to 3 can be effectively used in a flexible display.

Although particular embodiments of the present invention have been shown and described, it will be understood by those skilled in the art that it is not intended to limit the present invention to the preferred embodiments, and it will be obvious to those skilled in the art that various changes and modifications may be made without departing from the spirit and scope of the invention.

The scope of the present invention, therefore, is to be defined by the appended claims and equivalents thereof.

1. A hard coating film for a flexible display, comprising:
a transparent substrate;
a first hard coating layer formed on one surface of the transparent substrate; and
a second hard coating layer formed on the other surface of the transparent substrate,
wherein each of the first hard coating layer and the second hard coating layer has a thickness of 5 to 50 μm and satisfies a stiffness of 15 to 130 kPa·m, which is defined by the following Equation 1:
Stiffness (kPa·m)=Compressive Elastic Modulus (GPa)×Layer Thickness (μm). [Equation 1]

2. The hard coating film of claim 1, wherein the first hard coating layer has a compressive elastic modulus of 3,000 to 15,000 MPa, and the second hard coating layer has a compressive elastic modulus of 3,000 to 10,000 MPa.

3. The hard coating film of claim 1, wherein the first hard coating layer has a pencil hardness of 4H or more which is tested with a load of 750 g, and the second hard coating layer has a pencil hardness of H or more which is tested with a load of 750 g.

4. The hard coating film of claim 1, wherein the film has a pencil hardness of H or more which is tested with a load of 750 g in the state that the second hard coating layer is attached to an adhesive.

5. The hard coating film of claim 4, wherein the adhesive has a thickness of 25 μm or more.

6. The hard coating film of claim 4, wherein the adhesive is a pressure sensitive adhesive (PSA) or an optically clear adhesive (OCA).

7. The hard coating film of claim 1, wherein the first and second hard coating layers are formed from a hard coating composition comprising a photocurable resin, a photoinitiator and a solvent respectively.

8. A flexible display having the hard coating film of claim 1.

9. A flexible display having the hard coating film of claim 2.

10. A flexible display having the hard coating film of claim 3.

11. A flexible display having the hard coating film of claim 4.

12. A flexible display having the hard coating film of claim 5.

13. A flexible display having the hard coating film of claim 6.

14. A flexible display having the hard coating film of claim 7.
